(19) United States
(12) Patent Application Publication
(10) Pub. No.: US 2013/0004825 A1
(43) Pub. Date: Jan. 3, 2013

(54) BATTERY

(75) Inventor: Masanori KOGURE, Tokyo (JP)

(73) Assignee: MITSUBISHI HEAVY INDUSTRIES, LTD., Tokyo (JP)

(21) Appl. No.: 13/535,692

(22) Filed: Jun. 28, 2012

(30) Foreign Application Priority Data
Jun. 30, 2011 (JP) 2011-146525

(51) Int. Cl. H01M 2/06; H01M 2/18; H01M 2/30

(52) U.S. Cl. 429/136; 429/163; 429/179

(57) ABSTRACT

The battery according to the present invention includes, a first electrode plate which has a potential of a first polarity; a second electrode plate which includes a contact unit, and has a potential of a second polarity; a separator which is arranged between the first electrode plate and the second electrode plate; and a conductive battery container in which the first electrode plate, the second electrode plate, and the separator are accommodated, and in which the contact unit comes into contact with the battery container.

### BACKGROUND OF THE INVENTION

1. Field of the Invention

The present invention relates to a battery, in particular, to a battery of which the performance is improved.

2. Description of Related Art

Among batteries, there is a primary battery which performs discharging only, or a secondary battery which is chargeable and dischargeable. These are configured by sealing a stacked electrode body in which electrode plates, that is, a positive plate and a negative plate, are stacked through a separator in a battery container, and are generally used for supplying power for driving an electric power load such as a motor in a battery system.

However, in these batteries, it is known that the performance of the batteries degrades due to deterioration, and there are cases of failure of the batteries as a result. As a reason for the deterioration, for example, there is heat which occurs inside the battery container due to a discharge, or a charge and discharge, a reaction between the battery container and an electrolytic solution, or the like.

Therefore, a battery which includes a radiator plate for radiating the heat inside the battery container to the outside of the battery container (refer to Patent Document 1 as mentioned below), a battery which prevents the above reaction by connecting the positive terminal of the battery and a conductive battery container through a conductor in order to prevent the deterioration of the battery, and by making the potential of the battery container the same as that of the positive electrode (refer to Patent Document 2 as mentioned below), or the like, has been developed.
Patent Document 1: Japanese Unexamined Patent Application Publication No. 2010-287487
Patent Document 2: Japanese Unexamined Patent Application Publication No. 2008-186591

However, in the battery in Patent Document 1, because a radiator plate is accommodated in a battery container of a certain size, it is necessary to reduce the lengths of, or the number of electrode plates, or the like, compared to a case where the radiator plate is not accommodated therein. As a result, there is concern that the performance of discharging, or charging or discharging of the battery may be degraded.

In addition, in the battery in Patent Document 2, because the above described conductor is arranged on the outside of the battery container, another member of a battery system comes into contact with the conductor, or the like, due to a vibration or the like of the battery system in which the battery is used. As a result, there is a concern of the conductor is deviated from a predetermined position, and the above reaction progressing.

Therefore, an object of the present invention is to provide a battery in which the above described problems are solved at the same time by adopting a simple configuration, and to improve the performance of the battery.

### SUMMARY OF THE INVENTION

In order to achieve the above object, according to an aspect of the present invention, a battery includes a first electrode plate with a potential of a first polarity, a second electrode plate with a potential of a second polarity, and which includes a connecting unit, a separator which is arranged between the first electrode plate and the second electrode plate, and a conductive battery container in which the first electrode plate, the second electrode plate, and the separator are accommodated, wherein the connecting unit comes into contact with the battery container.

That is, with this configuration, it is possible to make the battery container have a second polarity by causing the connecting unit included in the second electrode plate to come into contact with the conductive battery container from the inside of the battery container, and to radiate heat inside the battery container from the battery container through the connecting unit.

According to a battery of the present invention, it is possible to provide a battery in which the above described problems relating to degradation of the battery due to heat inside the battery container or a reaction between electrolytic solution and the battery container is prevented at the same time, and the performance of the battery is improved.

### BRIEF DESCRIPTION OF THE DRAWINGS

FIG. 1 is a schematic diagram of a battery according to embodiments of the present invention. FIG. 1 (a) is a perspective view of the battery when seen from an XZ plane, and FIG. 1(b) is a YZ cross-sectional view of FIG. 1(a) which is taken along line A-A′.

FIG. 2 is a schematic diagram of an electrode plate which is used in the battery according to the embodiment of the present invention. FIG. 2 (a) is a schematic diagram of a positive electrode plate, and FIG. 2 (b) is a schematic diagram of a negative electrode plate.

FIG. 3 is a schematic diagram which shows a modified example of a positive electrode plate which is used in a battery of the embodiment of the present invention.

FIG. 4 is a schematic diagram of a further modified example of the positive electrode plate which is used in the battery of the embodiment of the present invention, and a battery in which the positive electrode plate is used. FIG. 4 (a) is a schematic diagram which shows the modified example of the positive electrode plate. FIG. 4 (b) is a perspective view of the battery in which the positive electrode plate is used when seen from an XZ plane.

### DETAILED DESCRIPTION OF THE INVENTION

The battery according to the present invention is a battery in which an uncoated portion, of any one of the electrode plates of a positive electrode plate or a negative electrode plate of which a base material is coated with an electrode active material, is arranged by being in contact with a conductive battery container. Hereinafter, the battery according to the embodiment will be described in detail with reference to drawings.

In addition, as a battery according to the embodiment, it is possible to use any one of a primary battery, a secondary battery, or the like, however, as an example of the battery, a battery which can be charged or discharged, for example, a lithium ion secondary battery as a storage battery will be described here.

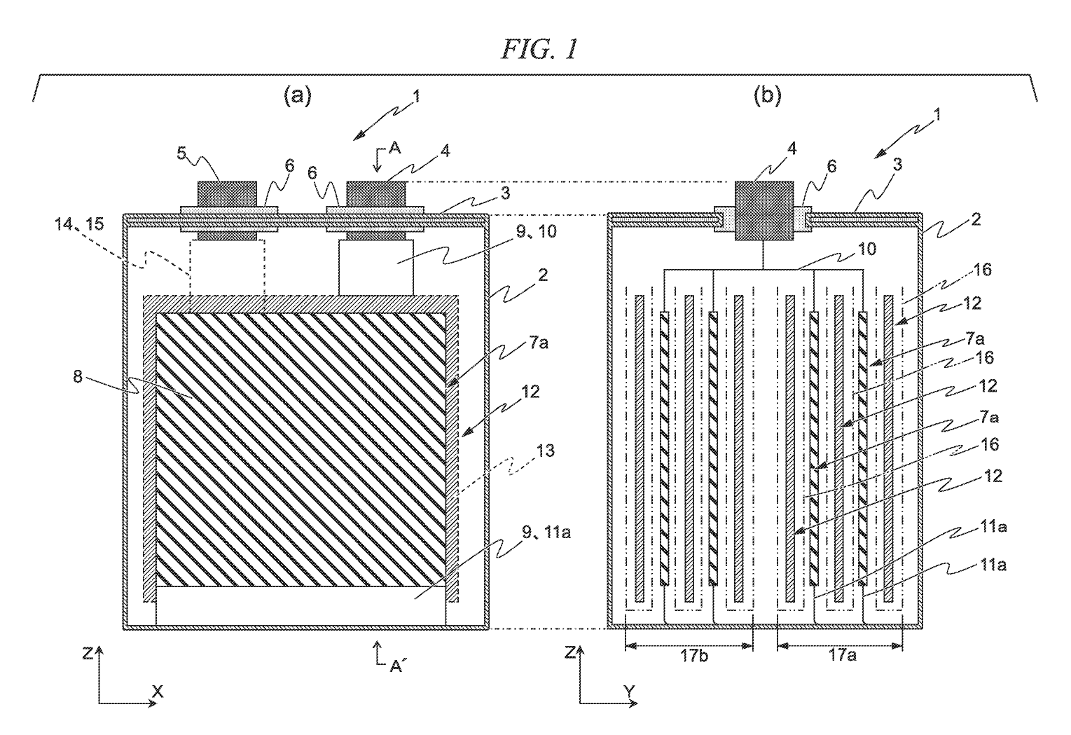

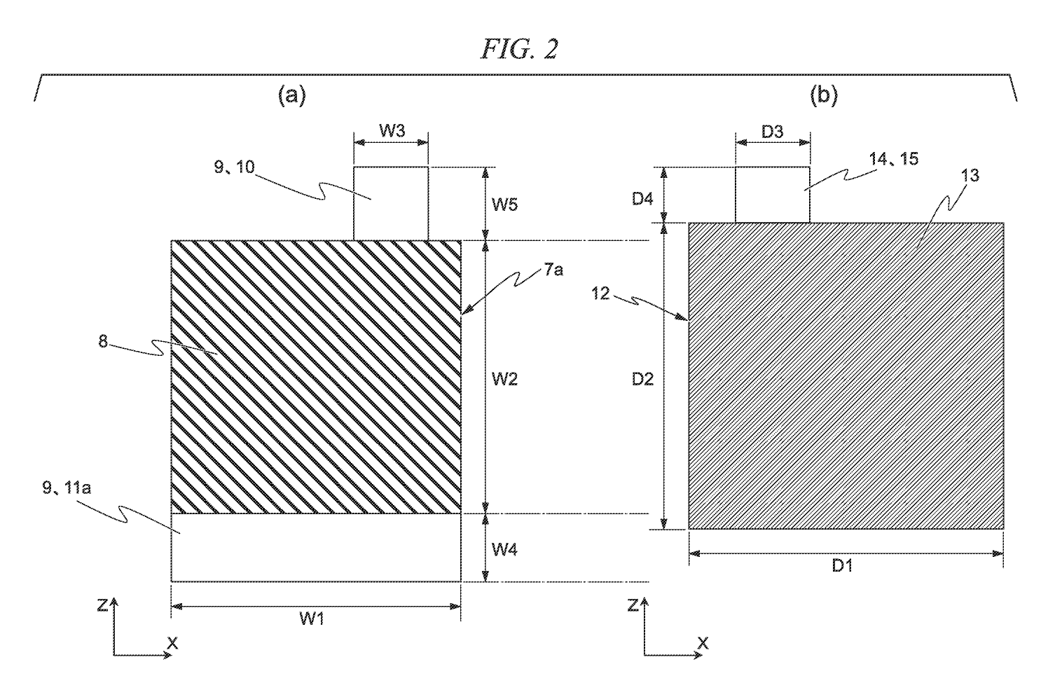

A battery 1 according to the embodiment will be described with reference to FIGS. 1 and 2. FIG. 1 (a) is a schematically perspective view when seen from the front of the battery 1 (XZ plane), and FIG. 1 (b) is a cross-sectional schematic diagram on a YZ plane of FIG. 1 (a) with taken along line A-A′. In addition, all of the drawings to be used hereinafter use an orthogonal coordinate system. Further, because FIG. 1 (a) is a schematic diagram for promoting understanding, each element or part shown in FIG. 1 (b) is not necessarily described in FIG. 1 (a).

First, the battery 1 includes a square-shaped conductive container main body 2 (for example, made of a metal such as aluminum) with a substantially rectangular-shaped bottom in the XY plane, and with a wall surface which extends in the Z axis direction from all sides of the substantially rectangular shape, a stacked electrode body 17 which is accommodated in the container body 2, and in which a positive electrode plate 7a and a negative electrode plate 12 are stacked through a separator 16, and a lid 3 which encloses the container main body 2 after accommodating the stacked electrode body 17 in the container main body 2 (“a battery container” is formed by enclosing the container main body 2 and the lid 3 using laser welding or the like). In addition, an electrolytic solution, or an electrolyte is stored in the battery container, though it is not shown.

Here, the lid 3 is formed of the same conductive material as that of the container main body 2. In addition, the lid 3 includes, for example, cylindrical electrode terminals (a positive terminal 4 and a negative terminal 5) which are arranged by penetrating the lid 3, and an insulating resin 6 (for example, an insulating body such as plastic resin) which fixes the electrode terminals to the lid 3 and which electrically insulates the electrode terminals and the lid 3.

Hereinafter, as an example, the stacked electrode body 17 (two stacked electrode bodies 17a and 17b here) will be described as a stacked-type electrode body in which the plurality of positive electrode plates 7 and the plurality of negative electrode plates 12 are sequentially stacked through a separator 16.

The positive electrode plate 7a is formed such that a metal foil for a positive electrode, such as aluminum (hereinafter, also referred to as “a positive electrode base material), is coated with a positive electrode active material such as lithium manganese on both surfaces thereof, and then is punched. The positive electrode plate 7 includes a substantially rectangular portion in which the positive electrode base material is coated with the positive electrode active material (hereinafter, referred to as “a positive electrode coated unit 8”), and a substantially rectangular portion in which the positive electrode base material is not coated with the positive electrode active material (hereinafter, referred to as “a positive electrode non-coated unit 9”).

A substantially rectangular positive electrode tab 10 which is connected to the side located to in the +Z direction between the two sides with a length along the X direction of the positive electrode coated unit 8, and a substantially rectangular contact unit 11a which is connected to a side located to the −Z direction between the two sides, are positive electrode non-coated units 9.

The connection relationship between these positive electrode non-coated units 9 and the positive electrode coated unit 8 is shown as in FIG. 2 (a).

That is, the positive electrode coated unit 8 is a substantially rectangular shape with a length “W1” in the X direction, and a length “W2” in the Z direction. In addition, the positive electrode tab 10 as one of the positive electrode non-coated units 9 is a substantially rectangular shape with a length “W3” in the X direction, and a length “W5” in the Z direction, and when a virtual line (hereinafter, referred to as “a positive electrode virtual line”) is drawn in the Z direction from the center of the width of the positive electrode coated unit 8 in the X direction, the positive electrode tab is located to the +X direction from the positive electrode virtual line, located at the inner side of the positive electrode coated unit 8 in the X direction, and is connected to the positive electrode coated unit 8 so as to be integrated with the positive electrode coated unit 8 (accordingly, 0 W3 {(W1) 2}). Further, the contact unit 11a as one of the positive electrode non-coated units 9 is a substantially rectangular shape with a length “W1” in the X direction, and a length “W4” in the Z direction, and is connected to the side located to the −Z direction of the positive electrode coated unit 8 without slippage in the X direction so as to be integrated with the positive electrode coated unit.

In addition, the “W5” is a length which is sufficient to be electrically connected to the positive terminal 4, and the “W4” is the length which is sufficient to physically come into contact with the battery container without

electrically coming into contact with the negative electrode plate 12.

On the other hand, the negative electrode plate 12 is formed such that metal foil for a negative electrode (hereinafter, referred to as “a negative electrode base material”) such as copper is coated with a negative electrode active material such as carbon on both surfaces thereof, and then is punched. The negative electrode plate 12 includes a substantially rectangular portion in which the negative electrode base material is coated with a negative electrode active material (hereinafter, referred to as “a negative electrode coated unit” 13), and a substantially rectangular portion in which the negative electrode base material is not coated with the negative electrode active material (hereinafter, referred to as “a negative electrode non-coated unit” 14).

A substantially rectangular negative electrode tab 15, which is connected to a side located to the +Z direction between two sides along the X direction of the negative electrode coated unit 13, is the negative electrode non-coated unit 14.

The relationship between the negative electrode non-coated unit 14 and the negative electrode coated unit 13 is shown as in FIG. 2 (b).

That is, the negative electrode coated unit 13 is a substantially rectangular shape with a length “D1” in the X direction, and a length “D2” in the Z direction. In addition, the negative electrode tab 15 as the negative electrode non-coated unit 14 is a substantially rectangular shape with a length “D3” in the X direction, and a length “D4” in the Z direction. When a virtual line is drawn in the Z direction from the center of the width of the negative electrode coated unit 13 in the X direction (hereinafter, referred to as “a negative electrode virtual line”), the negative electrode tab 15 is located to the −X direction from the negative electrode virtual line, located at the inner side of the negative electrode coated unit 13 in the X direction, and is connected to the negative electrode coated unit 13 so as to be integrated with the negative electrode coated unit (accordingly, 0 D3 {(D1) 2}).

The size of the negative electrode coated unit 13 on the XZ plane, which is substantially rectangular, is a size which the negative electrode coated unit 13 can be stored in the battery container without bending, that is, smaller than the internal diameter of the battery container on the XZ plane. In addition, the size of the negative electrode coated unit 13 on the XZ plane which is substantially rectangular is larger than the size of the positive electrode coated unit 8 on the XZ plane which is substantially rectangular. That is, 0 W1 D1, and 0 W2 D2.

Accordingly, as shown in FIG. 1 (a), the positive electrode coated unit 8 is arranged inside the plane of the negative electrode coated unit 13 when seen in the Y direction. In addition, the negative electrode tab 15 is arranged at a position which is not overlapped with the positive electrode tab 10 on the XZ plane, because the positive electrode plate 7a and the negative electrode plate 12 are sequentially stacked in the Y direction through the separator 16 by substantially aligning the positive electrode virtual line and the negative electrode virtual line on the XZ plane.

According to the embodiment, as shown in FIG. 1 (b), the separator 16 is a bag-shaped separator. Here, a state, where the entire surface of the coated unit of the electrode plate (the entire surface of the negative electrode coated unit 13 here) is accommodated in the inside of the bag-shaped separator, and the electrode tab (the negative electrode tab 15 here) is protruded to the outside from the inside of the bag, is referred to as “inclusion”.

By making the separator 16 be bag-shaped, it is possible to sufficiently prevent the negative electrode plate 12 from coming into contact with the battery container which is charged with a positive electrode potential, and to sufficiently prevent the negative electrode plate 12 from coming into contact with the positive electrode plate 7.

When such a prevention function is achieved by adjusting the size of the separator, it is not necessary to make the separator be bag-shaped. Accordingly, the shape of the separator may be a simple rectangular sheet shape.

In addition, when the electrode plates are stacked, the negative electrode plate 12 which is included in the bag-shaped separator 16 is firstly stacked, and the positive electrode plate 7a is stacked on the separator 16 (to the +Y direction) of the negative electrode plate 12, and then the negative electrode plate 12 which is included in the bag-shaped separator 16 is stacked on the positive electrode plate 7a (to the +Y direction). At this time, the plurality of negative electrode plates 12 are stacked by aligning the positions of each of the negative electrode tabs 15 thereof on the XZ plane. In addition, the plurality of positive electrode plates 7a are stacked by aligning the positions of each of the positive electrode tabs 10 thereof on the XZ plane.

By sequentially repeating this processing, finally the stacked electrode body 17 is formed which is configured by the plurality of positive electrode plates 7a, and the plurality of negative electrode plates 12, and in which the negative electrode plates 12 are arranged at both ends in the Y direction, when the stacked electrode body 17 is seen from the X direction. In FIG. 1 (b), an example is shown in which two stacked electrode bodies 17, which are the same as each other (shown in the figure with respective numbers 17a and 17b), are stored in the battery container.

In addition, the all positive electrode tabs 10, which are aligned at substantially the same position when seen from the Y direction, are electrically connected to the positive terminal 4 by riveting, welding, or the like. At this time, the positive electrode tabs 10 may be directly connected to the positive terminal 4, and a metal lead for a positive electrode may be interposed between the positive electrode tabs 10 and the positive terminal 4. Further, the entire negative electrode tabs 15, which are aligned at substantially the same position when seen from the Y direction, are electrically connected to the negative terminal 5 by riveting, welding, or the like. At this time, the negative electrode tabs 15 may be directly connected to the negative terminal 5, and a metal lead for a negative electrode may be interposed between the negative electrode tabs 15 and the negative terminal 5.

With the above described configuration, in the battery 1 according to the embodiment, the contact unit 11a of the positive electrode plate 7a as a part of the stacked electrode body 17 which is accommodated inside the battery container comes into contact with the battery container, in detail, the base of the container main body 2 by gravity. As shown in FIG. 1 (b), when the tip end of the contact unit 11a is arranged to be sandwiched between the bag-shaped separator 16 and the base of the container main body 2, it is possible to realize a structure in which the contact unit 11a reliably comes into contact with the base of the container main body 2.

Because the contact unit 11a as the positive electrode base material is made of metal with good thermal conductivity, heat generated inside the stacked electrode body 17 is subject to fast heat conduction to the battery container, and can be radiated. Accordingly, as a result, it is possible to prevent the battery from deteriorating. At this time, it is not necessary to reduce the size, or the number of plates of the electrode plate or the like, because the contact unit 11a is used which is formed of the positive electrode base material as one of basic constituent members of the battery, without arranging a member other than the basic constituent members of the battery inside the battery container as in the radiator plate in Japanese Unexamined Patent Publication Application No. 2010-287487.

In addition, because it is possible to electrically connect the positive electrode plate 7a and the battery container to each other inside the conductive battery container, and to make the battery container have the same potential as that of the positive electrode plate 7a, that is, substantially the same potential as that of the positive terminal 4, the reaction between the battery container and the electrolyte can be prevented. At this time, because the contact unit 11a is a part of the positive electrode plate 7a, not a member which is arranged outside the battery container as in Japanese Unexamined Patent Publication Application No. 2008-186591, and comes into contact with the base of the battery container by being pressed by the weight of the stacked electrode body, or comes into contact with the base due to gravity, there is no concern of the contact unit's departing from the base, and handling the battery 1 also becomes easy.

In addition, in general, when the conductive battery container is used, an insulating member such as an insulating plate or an insulating sheet is arranged between the inside of the battery container and the stacked electrode body in order that the stacked electrode body is not electrically connected to the battery container. This is a treatment which is performed so that the positive electrode plate and the negative electrode plate of the stacked electrode body are not electrically shorted. However, in the battery 1, because the negative electrode plate 12 is included in the bag-shaped separator 16, the negative electrode plate 12 and the positive electrode plate 7a are not electrically shorted. In addition, because the positive electrode plate 7a has a configuration in which the contact unit 11a thereof comes into contact with the base of the battery container, the insulating member is not necessary. According to the design, the insulating member may be still arranged between another wall face in the inner wall of the battery container other than the base and the stacked electrode body.

Accordingly, the battery 1 according to the embodiment not only improves the performance of the battery, but also contributes to cost reduction.

In the above described battery 1, as shown in FIG. 2 (a), the contact unit 11a is connected to a side located to the −Z direction between two sides along the X direction of the positive electrode coated unit 8 without a gap. However, the shape of the contact unit 11a may be a structure in which the gap is present.

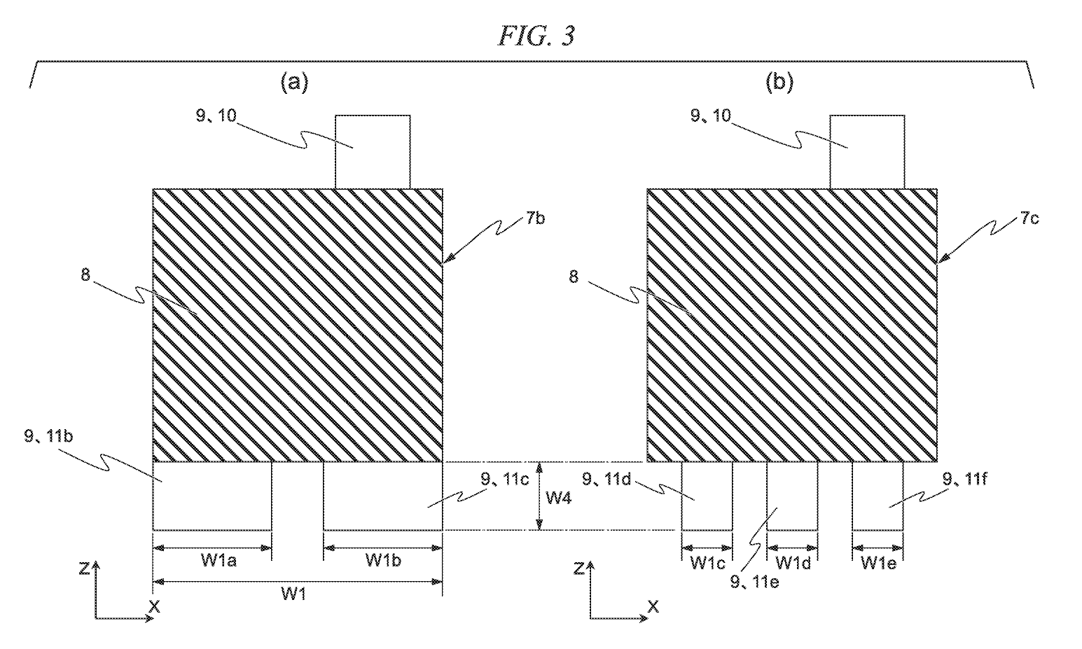

In FIG. 3(a), a positive electrode plate 7b of the battery as a modified example is shown, and a positive electrode plate 7c of the battery as a modified example is shown in FIG. 3 (b). In these batteries as modified examples, because the positive electrode plate 7b or the positive electrode plate 7c is switched only with the positive electrode plate 7a of the battery 1, other configurations are the same as those of the above described battery 1. Therefore, descriptions of the other configurations will be omitted here.

The positive electrode plate 7b is configured in order that the contact unit 11a is divided into two in the X direction in the vicinity of the positive electrode virtual line, and has a configuration of having two portions of a contact unit 11b of which the width in the X direction is “W1a”, and a contact unit 11c of which the width in the X direction is “W1b” (0 W1a+Wlb W1, in detail). In addition, these two portions are arranged so as to have an opening in the vicinity of the positive electrode virtual line. With this configuration, it is possible to make the electrolyte solution effectively infiltrate into, or circulate in the electrode plate compared to a case of the contact unit 11a.

In addition, the electrode plate 7c is configured in order that the contact unit 11a is divided into three in the X direction, and has a configuration of having three portions of a contact unit 11d of which the width in the X direction is “W1c”, a contact unit 11e of which the width in the X direction is “W1d”, and a contact unit 11f of which the width in the X direction is “W1e” (0 W1c+W1d+W1e W1, in detail). In addition, these three portions are arranged so as to have an opening each other. With this configuration, it is possible to make the electrolyte effectively infiltrate into, or circulate in the electrode plate compared to a case of the contact unit 11a.

Further, because the number of openings is increased compared to a case where the positive electrode plate is divided into two, as shown in FIG. 3 (a), it is possible to make the electrolyte solution more effectively infiltrate into, or circulate in the electrode plate by having such three portions.

The battery according to the modified example is effective similarly to the above described battery 1, and is able to further improve the performance of the battery, because it is possible to make the electrolyte effectively infiltrate into, or circulate in the electrode plate, as well, in this manner.

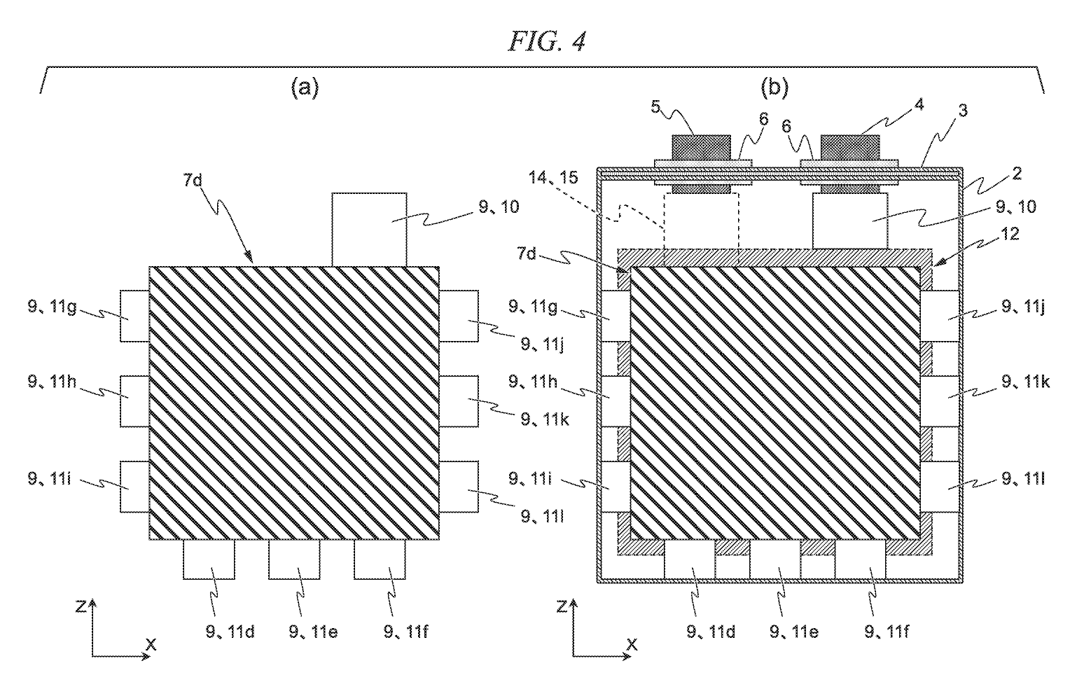

In addition, a battery of another modified example is shown in FIG. 4 (b). As shown in FIG. 4 (a), the battery in FIG. 4 (b) uses a positive electrode plate 7d having contact units 11g, 11 h, and 11i corresponding to the contact units 11d, 11e, and 11f as the positive electrode non-coated units 9 at a side located to the −X direction of two sides along the Z direction of the positive electrode plate 7c (refer to FIG. 3 (b)), and contact units 11j, 11k, and 11l corresponding to the contact units 11d, 11e, and 11f as the positive electrode non-coated units 9 at a side located to the +X direction of the two sides. Because in the battery as the modified example, only the positive electrode plate 7a of the battery 1 is switched with the positive electrode plate 7d, other configurations are the same as those of the above described battery 1, accordingly, descriptions thereof will be omitted here.

In the positive electrode plate 7d, not only the contact units 11d, 11e, and 11f come into contact with the base of the battery container, but also the contact units 11g, 11h, 11i, 11j, 11k, and 11l come into contact with a side wall of the battery container, accordingly, it is possible to make the heat generated inside the stacked electrode body 17 be conducted to the battery container quickly, and be radiated compared to the battery 1 in FIG. 1. In addition, the circulation of the electrolyte is also maintained, because each of the contact units are arranged so as to form the opening between the contact units 11g, 11h, 11i, 11j, 11k, and 11l.

The present invention is not limited to the above described embodiments, the modified examples, or combinations thereof, and can be variously modified without departing from the scope of the present invention. For example, although described as a rectangular shape, the shape of the battery container may be a cylindrical shape. Similarly, the stacked electrode body 17 may be an electrode body in which a plurality of positive electrode plates, and a plurality of negative electrode plates are sequentially stacked, respectively, through the separator (stacked-type electrode body), or an electrode body in which one positive electrode plate and one negative electrode plate are stacked through one separator, and are wound (winding-type electrode body). In addition, when the electrode body 17 is the stacked-type electrode body, a design is possible where there are one or more positive electrode plates 7 and negative electrode plates 12, that is, an appropriate plurality.

In addition, in the above described embodiments, or the modified examples thereof, the contact unit 11 is the positive electrode base material. However, the contact unit 11 may be connected to the positive electrode base material by using welding or the like, after formed separately from the positive electrode base material.

Further, in the above described embodiments, or the modified examples thereof, the contact unit 11 is formed separately from the positive electrode tab 10. However, it is possible to make the positive electrode tab 10 function as the contact unit 11 by integrally forming these.

In addition, in the embodiment and the modified examples, the contact unit 11 is arranged in the positive plate 7 in order to make the battery container have the positive electrode potential. However, according to a material of the battery (active material, electrolyte solution, or the like), a configuration corresponding to the contact unit 11 may be arranged in the negative plate 12 in order to make the battery container have a negative potential. In this case, if descriptions corresponding to the positive electrode plate 7 which have been described in the battery 1 are switched with descriptions corresponding to the negative plate 12, the configuration of the battery is easily understood.

What is claimed is:

1. A battery comprising:
a first electrode plate which has a potential of a first polarity;
a second electrode plate which includes a contact unit, and has a potential of a second polarity;
a separator which is arranged between the first electrode plate and the second electrode plate; and
a conductive battery container in which the first electrode plate, the second electrode plate, and the separator are accommodated,
wherein the contact unit comes into contact with the battery container.

2. The battery according to claim 1,
wherein the battery container includes a lid in which a first electrode terminal and a second electrode terminal are arranged through an insulating body, and a container main body, and
wherein the first electrode plate is electrically connected to the first electrode terminal, the second electrode plate is electrically connected to the second electrode terminal, and the contact unit comes into contact with the container body.

3. The battery according to claim 2,
wherein the second electrode plate includes a coated unit in which a base material is coated with an electrode active material, and a non-coated unit in which the base material is not coated with the electrode active material, and
wherein the contact unit is the non-coated unit.

4. The battery according to claim 3,
wherein the contact unit comes into contact with a base of the container main body.

5. The battery according to claim 4,
wherein the separator is bag-shaped, and encloses the first electrode plate in a state of the inclusion.

6. The battery according to claim 1,
wherein the first polarity is a negative polarity, the first electrode plate is a negative electrode plate, the second polarity is a positive polarity, and the second electrode plate is a positive electrode plate.

7. The battery according to claim 2,
wherein the first polarity is a negative polarity, the first electrode plate is a negative electrode plate, the second polarity is a positive polarity, and the second electrode plate is a positive electrode plate.

8. The battery according to claim 3,
wherein the first polarity is a negative polarity, the first electrode plate is a negative electrode plate, the second polarity is a positive polarity, and the second electrode plate is a positive electrode plate.

9. The battery according to claim 4,
wherein the first polarity is a negative polarity, the first electrode plate is a negative electrode plate, the second polarity is a positive polarity, and the second electrode plate is a positive electrode plate.

10. The battery according to claim 5,
wherein the first polarity is a negative polarity, the first electrode plate is a negative electrode plate, the second polarity is a positive polarity, and the second electrode plate is a positive electrode plate.

11. The battery according to claim 1,
wherein the first polarity is the positive polarity, the first electrode plate is the positive electrode plate, the second polarity is the negative polarity, and the second electrode plate is the negative electrode plate.

12. The battery according to claim 2,
wherein the first polarity is the positive polarity, the first electrode plate is the positive electrode plate, the second polarity is the negative polarity, and the second electrode plate is the negative electrode plate.

13. The battery according to claim 3,
wherein the first polarity is the positive polarity, the first electrode plate is the positive electrode plate, the second polarity is the negative polarity, and the second electrode plate is the negative electrode plate.

14. The battery according to claim 4,
wherein the first polarity is the positive polarity, the first electrode plate is the positive electrode plate, the second polarity is the negative polarity, and the second electrode plate is the negative electrode plate.

15. The battery according to claim 5,
wherein the first polarity is the positive polarity, the first electrode plate is the positive electrode plate, the second polarity is the negative polarity, and the second electrode plate is the negative electrode plate.
